(19) United States
(12) Patent Application Publication
(10) Pub. No.: US 2020/0086724 A1
(43) Pub. Date: Mar. 19, 2020

(54) MULTI-POINT MECHANICAL ATTACHMENT METHOD FOR A LOAD BEARING TONNEAU STRUCTURE

(71) Applicant: Advanced Metal Products, Inc., West Bountiful, UT (US)

(72) Inventors: Jennifer Marie Aubrey, Bountiful, UT (US); David Christopher Paul Rosal, West Bountiful, UT (US); Scott Merrill Packer, Highland, UT (US)

(21) Appl. No.: 16/572,395

(22) Filed: Sep. 16, 2019

Related U.S. Application Data
(60) Provisional application No. 62/731,531, filed on Sep. 14, 2018.

(51) Int. Cl. B60J 7/04; B60J 7/19; E05D 15/26

(52) U.S. Cl. CPC B60J 7/042; E05Y 2900/548; E05D 15/26; B60J 7/198

(57) ABSTRACT

A system and method for providing a latch system assembly, the latch system assembly coupled to both sides of the bed of a vehicle, the latch system assembly including stationary rails and sliding rails, wherein the stationary rails are coupled to the vehicle bed rails and the sliding rails are able to slide and either lock or unlock portions of a tonneau cover to the bed rails, wherein the sliding rails may lock all sections of the tonneau cover, lock one section and unlock all others, or unlock one section and lock all others through simple sliding movement of the sliding portion.

### BACKGROUND

### Field of the Invention

This invention relates generally to tonneau covers. Specifically, the present invention is directed to obtaining an improved load bearing tonneau cover by providing a simpler design for a multi-point mechanical attachment system for securing the tonneau cover to the bed of a vehicle.

### Description of Related Art

A tonneau cover may describe a hard or soft cover used to protect unoccupied passenger seats in a convertible or roadster, or the cargo bed in a pickup truck. Hard tonneau covers may open by a hinging or folding mechanism while soft covers may open by rolling up.

A tonneau cover may be used to conceal cargo or protect cargo from the elements. When the tonneau cover is used, it may keep cargo out of the sun and provides extra security by keeping items out of sight.

Tonneau covers have been well documented in publications since their inception in the early 1900s as a means to cover or conceal cargo in a vehicle. Even though vehicles have evolved in design and function over the years, the design of marketable tonneau covers may have only evolved in terms of aesthetics rather than increased practical functionality.

The largest market for tonneau covers may be the pickup truck. It has been estimated that 98% of the tonneau covers made for this market serve the singular function of covering the cargo bed to compliment the look of the vehicle.

One style of tonneau cover is the soft cover. The soft tonneau cover may generally be made from fabrics or fabric composites that resist water and UV light damage. This may be the most common cover because of its low cost. This style may be made to retract or roll up or back into position. The soft tonneau cover may occupy the least amount of space and there are a variety of attachment and fastening methods that are employed to attach it to a pickup truck.

A second style of tonneau cover is the hard cover. The hard cover is typically made from fiberglass, hard plastic, rubber, aluminum or some combination of these or other materials. The tonneau covers made from fiberglass may be described as a single shell type cover that opens by a hinge at the cab portion of the bed. Because they are quite heavy, they may include pneumatically assisted cylinders for opening and closing. The hard tonneau covers are often made to order so that their color matches the color of the truck.

A variation of the hard tonneau cover is one that utilizes a series of foldable sections to cover the cargo portion of the bed. These sections can fold together from the rear to the front of the truck and stack near the cab to make use of the cargo portion of the truck bed. A variation of this design is to have a foldable section that opens from the side of the truck bed. The hard tonneau covers may either have locks located in the foldable panels or open from the inside of the bed. Typically, the covers that open from the inside of the bed rely on the factory locking tailgate to secure the bed contents. The hard tonneau cover is the next cost increment to not only cover the contents of the truck bed but to secure them as well with a lock system so that valuable items can be safely kept in the truck bed.

Both hard and soft tonneau covers may have a profile as low as possible with the top edge of the truck bed sides and tailgate for improved aesthetics. As a result, additional hardware may be needed to mount the tonneau cover to the inside walls of the truck bed.

One style of hard tonneau cover, fabricated from aluminum, has been developed to carry a load on the top while leaving the bed under the cover to carry additional items. This cover opens in a gull-wing manner with hinges secured across the middle of the truck bed allowing aluminum sections to open in the front behind the truck cab and at the tailgate. The utility is further increased by using boat style cleats for cargo tie downs. This style of tonneau cover is locked from the top of the cover and may have a protruding handle lock.

It is important to note that tonneau covers are aftermarket purchases that may need to be aesthetically pleasing to attract customers. Also, the owner may resist modifying a vehicle by making permanent changes such as drilling into the body or bed for attachment points.

There are some problems with existing tonneau covers. The soft tonneau covers may be limited to a covering function and cannot effectively be used for supporting objects. These tonneau covers may only protect the contents of the truck bed from weather. They may require multiple fasteners to be installed on the truck bed. It is a problem for many vehicle owners to drill holes in their vehicle for mounting these fasteners. In the event that it is desired to remove the cover altogether, the vehicle is left with exposed fasteners or if the fasteners are removed, permanent holes in the vehicle.

The single section hard tonneau cover, such as those made of fiberglass, may also require hardware mounted to the bed itself. This hardware may include hinges near the cab, gas struts on the sides and some sort of locking mechanism on the tailgate. In most cases, they are special ordered to be painted the color of the truck and a professional installer may need to be used for the installation.

There are several problems with this hard tonneau cover system. For example, the single section may only be opened as far as the gas struts allow. This means that nothing higher than the bed rails (if the cover is closed) could be put in the cargo section of the bed unless the hard tonneau cover itself is removed. If the hard tonneau cover is removed, it typically requires 2 people to undo hardware and lift the cover from the truck. This additional cost along with the yearly change in bed sizes for new truck models may make this a difficult and costly manufacturing/supply process.

Another problem with this hard tonneau cover design is the use of screws to attach hardware to the truck bed. A truck may experience extreme vibration during work and recreational use, especially if it is driven off road. Over a short amount of time, the thin sheet metal surrounding the screws may tend to wear, deform and enlarge leaving a heavy tonneau cover improperly secured to the vehicle.

Hard tonneau covers with folding sections may add the element of utility by folding back and allowing objects taller than the sides of the bed to be transported in the bed without removing the hard tonneau cover. Unfortunately, most of the designs for hard tonneau covers have a significant number of parts required for construction to achieve this design objective. This construction may include rails that must be attached to the inside of the bed rails and each foldable section must fit uniformly and rest on these rails.

If the inside measurement across the width of the truck bed at the tailgate is 2 to 4 inches less than the inside measurement taken across the bed at the cab (both measurements taken at rail height) as in many trucks, each folding section may need to be trapezoidal in shape for proper fit up with the bed rails. This taper varies with make, model and year, and is a tremendous difficulty and expense for manufacturers to deal with for the multitude of trapezoidal shaped folding sections.

Another matter that must be discussed is a latching mechanism that needs to be used to prevent the embodiments of the invention from moving during braking or acceleration of a vehicle. It seems that there are an infinite number of latch styles and types for many applications. They range from typical door latches used in homes to specialty latches found in the automotive and aerospace applications. The majority of these applications utilize latches that restrict one degree of freedom of each side of a hinged device. Simply stated, they are used to keep two components on a hinge from opening. The next most common hinge restricts 2 degrees of freedom and is used to maintain the closure of 2 components but resists lateral sliding along the hinge axis. The most common of these latches is a buckle latch. Buckle latches are common to travel trunks that need to resist the top and bottom sections from sliding apart at the closure plane. These latches are used when the hinge is not rigid enough to prevent an extra degree of freedom.

It is interesting to note that assembly engineering design convention typically utilizes latches that resist one degree of freedom for the use of the assembly. In other words, hinges are designed to resist load conditions except for the movement of opening and closing said hinged components. This latch style resists one degree of freedom, the motion to open the hinged components. There are many design opportunities where the hinge is compliant and cannot resist all of the degrees of freedom of the hinged assembly. One example of this case is the load bearing foldable tonneau cover. Compliant hinges may be used to join at least 2 load bearing sections of this foldable tonneau cover. Since the hinges are compliant, the forces of the load secured to the top of the cover and the tonneau cover itself must be reacted against the truck bed in some fashion. This latch system must react 3 degrees of freedom, 1) the force to lift the cover upwards, 2) the force to prevent the cover and load from sliding forwards when the truck brakes are suddenly applied, and 3) the force applied when the truck quickly accelerates. Each section of the tonneau cover that has an attached load must be able to react the forces to the bed of the truck. In addition, the latch system must be low profile and still allow each cover to fold on itself.

There are many other examples of assemblies and compliantly hinged components that could benefit from a latch solution that would eliminate at least 2 degrees of freedom.

When addressing the issue of a latching mechanism, common fastening and joining methods utilize screws, bolts, pins, anchors, staples etc. These mechanisms are then used to support the need for quick open and close systems commonly referred to as latch systems. Because economics play such a predominant roll in designing latch systems, most designers rely on mass produced latches to economically solve their design needs. These mass produced latches include draw locks, bolting latches, cam latches, swing latches, turn latches, gate latches, etc.

Unfortunately, these latch systems only perform well in mechanical designs that are simple and include a single degree of freedom, i.e. open or close along the same axis. They also become unsightly, costly and cumbersome when multiple latches are used in configurations that require multiple attachment points. To unlock multiple latches individually is time consuming and very frustrating. They are frustrating because it is very easy to forget to unlatch one of the many latches which in turn can cause damage to the components being latched. This leaves the designer with no choice but to design a custom latch solution that is simple for the end user yet versatile enough to perform multiple functions.

It would be an improvement over the prior art to provide a tonneau cover with a latch system that locks multiple components in place in different configurations. This system will be illustrated to show how a folding tonneau cover is attached to a pickup truck bed.

It is to be understood that the following description is only exemplary of the principles of the present invention and should not be viewed as narrowing the claims which follow.

### BRIEF SUMMARY

The present invention is a system and method for providing a latch system assembly, the latch system assembly coupled to both sides of the bed of a vehicle, the latch system assembly including stationary rails and sliding rails, wherein the stationary rails are coupled to the vehicle bed rails and the sliding rails are able to slide and either lock or unlock portions of a tonneau cover to the bed rails, wherein the sliding rails may lock all sections of the tonneau cover, lock one section and unlock all others, or unlock one section and lock all others through simple sliding movement of the sliding portion.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective top view of the overall design and layout of a tonneau cover of the prior art.

FIG. 2 is perspective top view of a tonneau cover disposed on bed rails in a first embodiment of the invention.

FIG. 3 is a perspective view of the underside of the tonneau cover shown in FIG. 2 with a first view of the first embodiment of the invention showing the slide latch system.

FIG. 4 is a close-up perspective view of the first embodiment of the slide latch system, with a view of a lock pin that engages with the slide latch.

FIG. 5 is a side view of the first embodiment of the invention showing the back side of the slide latch in the locked position.

FIG. 6 is the side view of the first embodiment of the invention shown in FIG. 5, now showing the cab tonneau section in the open position of the slide latch, with all remaining tonneau sections in the locked position.

FIG. 7 is the side view of the first embodiment of the invention shown in FIGS. 5 and 6, now showing the cab tonneau section in the locked position of the slide latch, with all remaining tonneau sections in the locked position.

FIG. 8 is the side view of the first embodiment of the invention shown in FIGS. 5, 6, and 7 from the view of the stationary latch position.

FIG. 9 is a close-up perspective view of the first embodiment of the slide latch system, with a view of one slide latch transferring linear motion to a rotational torsion bar and back to linear motion of the slide latch.

### DETAILED DESCRIPTION

Reference will now be made to the drawings in which the various embodiments of the present invention will be given numerical designations and in which the embodiments will be discussed so as to enable one skilled in the art to make and use the invention. It is to be understood that the following description illustrates embodiments of the present invention and should not be viewed as narrowing the claims which follow.

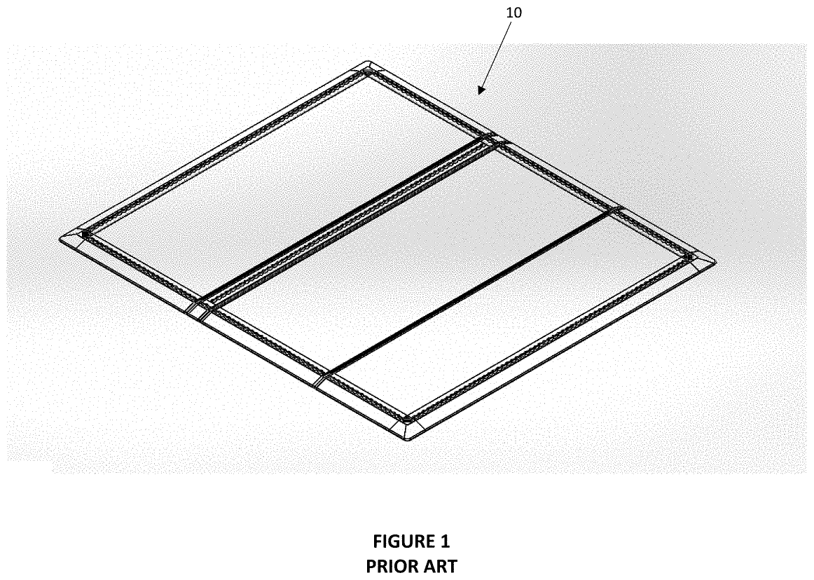

FIG. 1 shows a tonneau cover 10 as previously disclosed in the prior art. The tonneau cover 10 may be comprised of multiple tonneau cover sections. This tonneau cover 10 may incorporate elements required to support heavy loads even up to the pickup truck load carrying capacity, may fold to the cab of the truck to allow for tall objects in the bed of the truck, may fold to the cab to allow the attachment of goose neck and 5th wheel hitches without removing the tonneau cover 10 from the truck, may have no protruding handles, hinges, cleats or tie downs to be aesthetically pleasing to the eye, may have below surface attachment locations in thick cross section elements on the exterior and interior for attaching accessories to meet specialty customer needs according to their preference, may have no bolts or traditional fasteners for its construction, may have no conventional welds (Tig, Mig, or other conventional welding methods), may not require modification to the vehicle for attachment with holes or screws, may be easily removable, may have a unique hinge design that is durable and weather resistant, may allow for internal storage of frequently used items which include but are not limited to a tow strap, jumper cables, tie down straps, gloves, flashlight, etc., may have removable sections that can adjust the length of the tonneau structure to accommodate tool boxes, external fuel tanks, etc., and may include an improved latch system that allows for quick and easy opening, closing and locking the tonneau cover, and which is the subject of this document.

A diagram of this tonneau cover 10 is shown in FIG. 1. This tonneau cover 10 is a hard structure and may rest on top of the bed rails 18 of a pickup truck (not shown). The load bearing capability of the tonneau cover may come from the unique method of combining structural components on the underside of the load bearing tonneau cover 10.

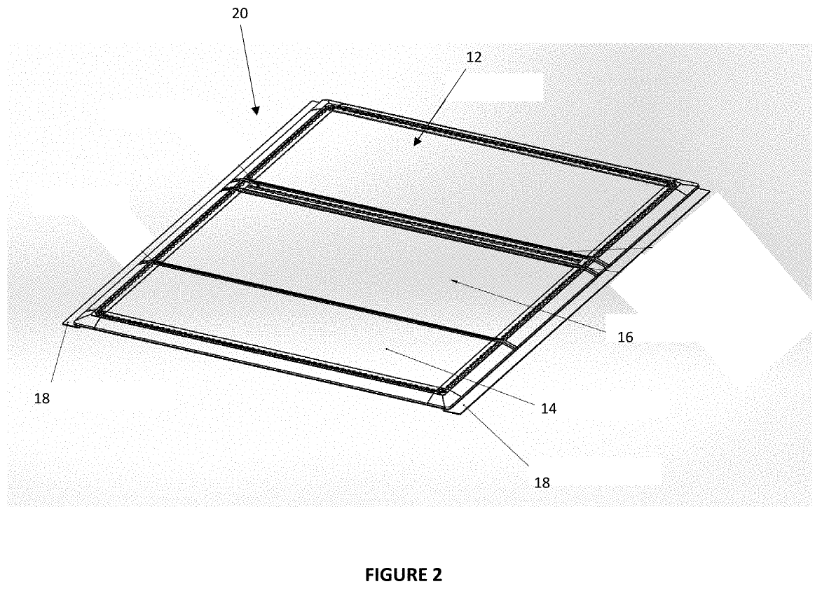

FIG. 2 is perspective top view of a first embodiment of a tonneau cover 20 of the present invention that is showing the relative position of bed rails 18 of a vehicle. Features and components may include a cab section next to the truck cab 12, a foldable section next to the truck tailgate 14, and another foldable section 16.

While FIG. 2 shows a total of three sections for the tonneau cover 20, it should be understood that more sections may be used in the tonneau cover 20. The total number of tonneau sections may vary, and this example shown in FIG. 2 is for illustration purposes only and should not be considered as limiting of the embodiments of the invention. Accordingly, other foldable sections may be included in the tonneau cover 20. For the purposes of the first embodiment of the invention, it may be assumed that there is one cab section 6 and three foldable sections 8 of the tonneau cover 20.

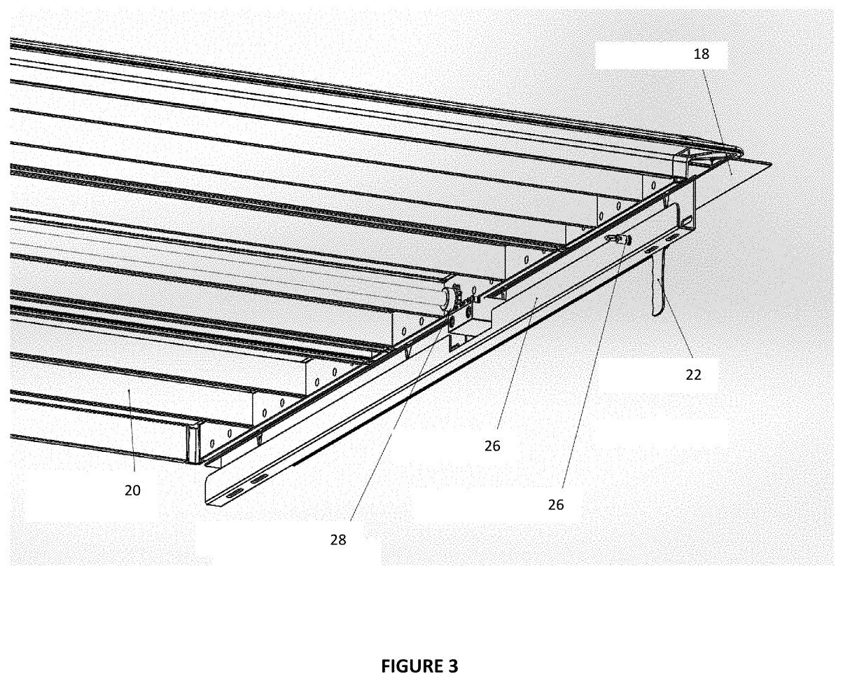

FIG. 3 is a perspective view of the underside of the tonneau cover 20 shown in FIG. 2 with a first view of the first embodiment of the invention showing the slide latch system.

This figure shows the underside of the tonneau cover 20, a partial bed rail 18, a stationary latch rail 26, a slide latch handle 22 which is coupled to a slide latch rail 24 that is behind the stationary latch rail and now yet shown, a spring lock plunger 26 and a torsion bar assembly 28.

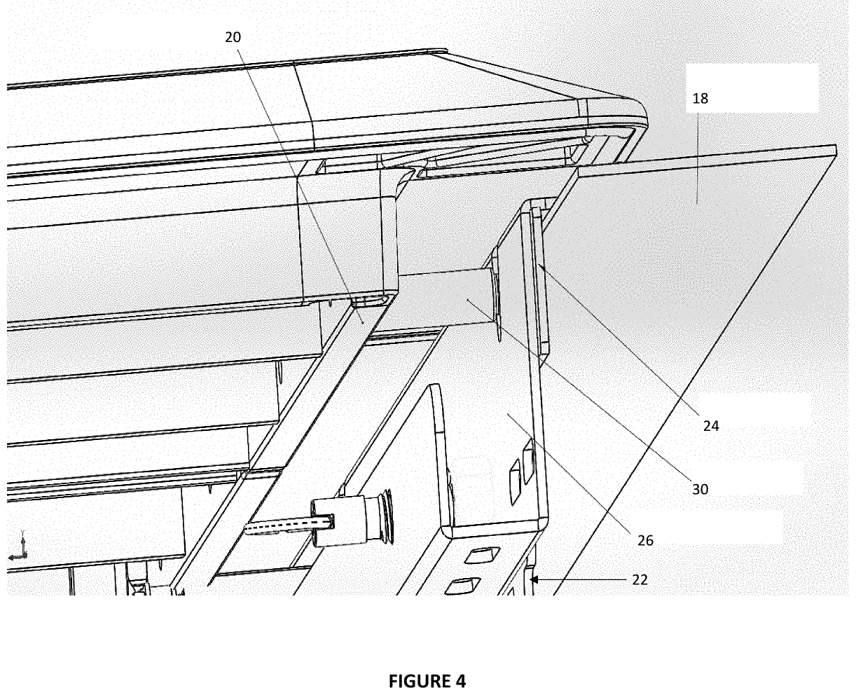

FIG. 4 provides a perspective and close-up view showing more detail of FIG. 3. This figure shows the tonneau cover 20, the bed rail 18, the stationary latch rail 26, the slide latch handle 22 and a slide latch rail 24. Also new in this figure is a lock pin 30.

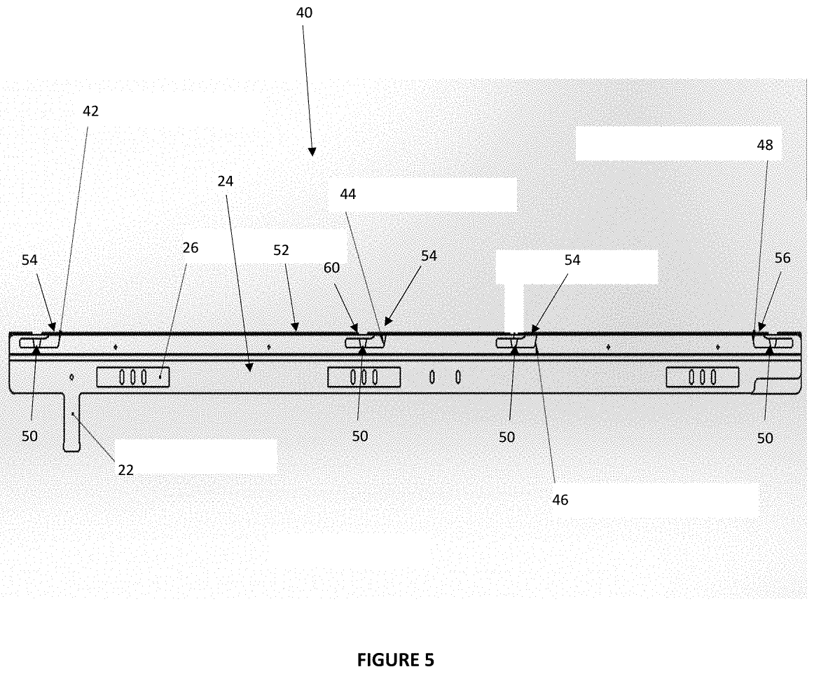

FIG. 5 is a side view of the slide latch system without the tonneau cover and the bed rail. This figure shows one of two slide lock assemblies 40 which are already partially shown in FIGS. 2, 3 and 4, each one of the slide lock assemblies disposed on opposite bed rails 18 of a vehicle. More specifically, the figure shows the back side of the slide latch rail 24.

Specific features of the slide lock assembly 40 may include four locking points: a tail section locking point 42, a midsection locking point 44, a folding section locking point 46 and a cab section locking point 48, assuming that the tonneau cover is shown with three folding sections 8 and one cab section 10.

The four locking points 42, 44, 46, 48 are partial holes through the slide latch rail 24. Thus, each of the four locking points 42, 44, 46, 48 has a finger 60 that extends partially over each of the locking points, with an opening 54 or 56 at each one of the locking points on a top edge 52 of the slide latch rail 24.

The stationary latch rail 26 is also shown partially visible through slide latch rail 24. The slide latch handle 22 is also shown coupled to the slide latch rail 24. Centered in each of the lock positions 42, 44, 46, 48 is shown a tonneau cover attachment pin 58. Each tonneau cover attachment pin 50 is coupled to a section of the tonneau cover 20 and keeps the tonneau cover 20 locked with the tonneau cover attachment pins 50 are engaged in a locked position.

It is noted that three of the locking points 42, 44, 46 have an opening 54 on one end which is opposite the opening 56 on the fourth locking point 48. This makes it possible to unlock either three tonneau cover sections while keeping one section locked, unlocking a single tonneau cover section while keeping the other three locked, or simultaneously locking all of them at the same time.

Operation of each of the slide lock assemblies 40 is as follows. The slide latch rail 24 is capable of sliding engagement with the stationary latch rail 26. As shown in FIG. 5, the sliding engagement is in the horizontal direction. The slide rail handle 22 is pushed forward or pulled back in order to cause movement of the slide latch rail 24 relative to the stationary latch rail 26.

The slide latch rail 24 may be disposed in one of three positions relative to the stationary latch rail 26. The first position is a middle or locked position where all four of the tonneau cover attachment pins 58 are engaged such that all of the sections 8, 10 of the tonneau cover 20 are locked to the bed rails 18 of the truck. This locked position is shown in FIG. 5.

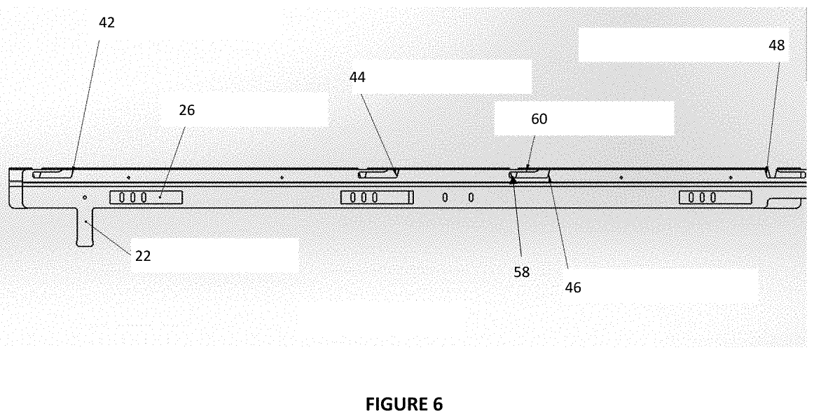

FIG. 6 provides the side view of the backside of the slide latch rail 24 where the slide latch handle 22 is pushed forward. In this position, three of the tonneau cover attachment pins 58 are still in a locked position and covered by the finger 60 at each locking point 42, 44, 46. However, it is now seen that the locking point 48 has moved so that the tonneau cover attachment pin 58 is no longer covered by the finger 60. The opening 56 is now exposing the tonneau cover attachment pin 58. The cab section of the tonneau cover 20 may now be folded back.

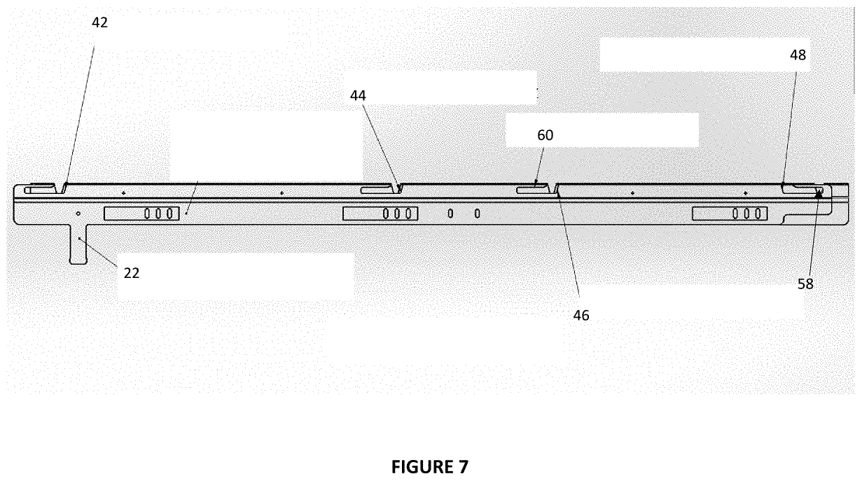

FIG. 7 provides another position of the slide latch rail 24 in the side view of the backside of the slide latch rail where the slide latch handle 22 is pulled backward relative to the stationary latch rail 26. In this position, three of the tonneau cover attachment pins 58 are now in an unlocked position and not covered by the finger 60 at each locking point 42, 44, 46. In contrast, it is now seen that the locking point 48 has moved so that the tonneau cover attachment pin 58 is now covered by the finger 60. Instead, the openings 54 are now exposing the tonneau cover attachment pins 58. The three sections of the tonneau cover 20 may now be folded back.

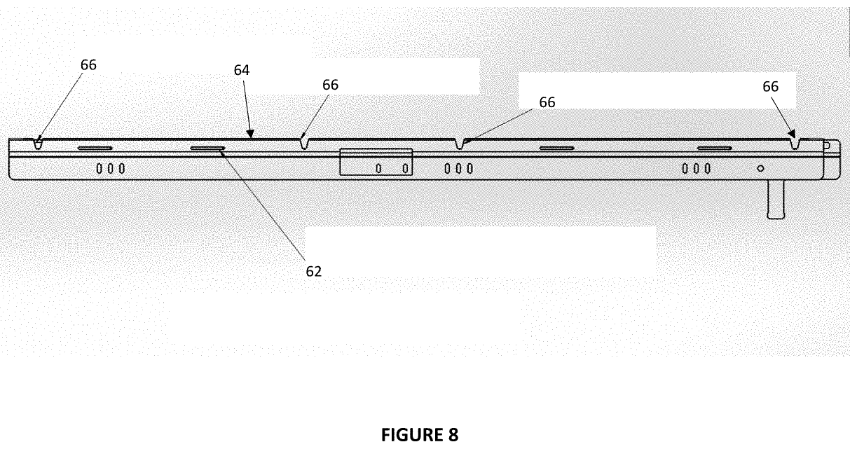

FIG. 8 is a side view of the front face of the stationary latch rail 26. This figure is provided to illustrate certain features. First, a plurality of slots 62 enables a rivet, bolt or similar feature to slidingly engage the slide latch rail 24 and the stationary latch rail 26 to each other.

Next, the top edge 64 of the stationary latch rail 26 includes notches 66 in which the tonneau cover attachment pins 58 are able to rest when all the sections 8, 10 of the tonneau cover 20 are laying flat on the bed rails 18. By providing a notch 66, the tonneau cover 20 is prevented from sliding when it is resting on the bed rails 18 of the truck.

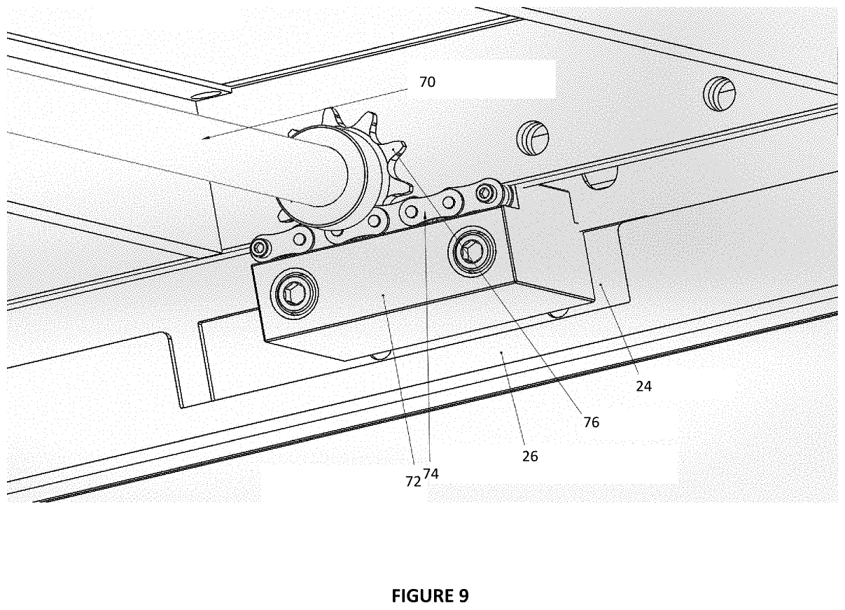

FIG. 9 is provided as a perspective and close-up detailed view of a portion of the torsion bar assembly 28. The torsion bar 70 may be used to couple together the slide latch assemblies 40 from each side of the bed rails 18 so that either slide latch handle 22 on either side of the truck bed can be used to operate the slide latch assemblies at the same time, and thus simultaneously lock all sections of the tonneau cover 20, unlock three sections and keep one section locked, or unlock one section and lock the other three.

This figure shows the torsion bar 70, a chain mounting block 72, a chain 74, a spur gear 76, the stationary latch rail 26 and a partial view of the slide latch rail 24. Using this torsion bar assembly 28, pulling or pushing on the slide latch rail 24 using the slide latch handle 22 may cause the torsion bar 70 to translate the linear motion of the slide latch rail 24 into rotation of the torsion bar and then back into linear motion of the side latch rail 24 on the other bed rail 18.

In summary, the system of the first embodiment includes a slide latch assembly for selectively locking sections of a tonneau cover to a bed of a vehicle, said slide latch assembly comprised of a first stationary latch rail coupled to a first bed rail of a vehicle, wherein the first stationary latch rail includes a plurality of notches in a top edge thereof, a first slide latch rail that is disposed parallel to and in slidingly engagement with the first stationary latch rail, wherein the first slide latch rail may be moved forward or backward a predetermined distance relative to the first stationary latch rail, wherein a plurality of locking points are disposed in a top edge of the first slide latch rail, wherein the plurality of notches in the first stationary latch rail are aligned with the plurality of locking points in the first slide latch rail, a plurality of tonneau cover attachment pins, wherein each of the plurality of tonneau cover attachment pins is coupled to a different section of a hinged and folding tonneau cover, wherein the plurality of tonneau cover pins rests in the plurality of notches of the first stationary latch rail when the tonneau cover is unfolded on the bed rails of the vehicle, and wherein the locking points of the first slide latch rail are either positioned to secure the plurality of tonneau cover pins in the plurality of notches or are positioned to expose the plurality of tonneau cover pins, by sliding the first slide latch rail forward or backward relative to the first stationary latch rail.

The same is accomplished on the opposite bed rail with a slide latch assembly mounted on the opposite bed rail.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112, paragraph 6 for any limitations of any of the claims herein, except for those in which the claim expressly uses the words ‘means for’ together with an associated function.

What is claimed is:

1. A slide latch assembly for selectively locking sections of a tonneau cover to a bed of a vehicle, said slide latch assembly comprised of:
a first stationary latch rail coupled to a first bed rail of a vehicle, wherein the first stationary latch rail includes a plurality of notches in a top edge thereof;
a first slide latch rail that is disposed parallel to and in slidingly engagement with the first stationary latch rail, wherein the first slide latch rail may be moved forward or backward a predetermined distance relative to the first stationary latch rail, wherein a plurality of locking points are disposed in a top edge of the first slide latch rail;
wherein the plurality of notches in the first stationary latch rail are aligned with the plurality of locking points in the first slide latch rail;
a plurality of tonneau cover attachment pins, wherein each of the plurality of tonneau cover attachment pins is coupled to a different section of a hinged and folding tonneau cover;
wherein the plurality of tonneau cover pins rests in the plurality of notches of the first stationary latch rail when the tonneau cover is unfolded on the bed rails of the vehicle; and
wherein the locking points of the first slide latch rail are either positioned to secure the plurality of tonneau cover pins in the plurality of notches or are positioned to expose the plurality of tonneau cover pins, by sliding the first slide latch rail forward or backward relative to the first stationary latch rail.

2. The slide latch assembly as defined in claim 1 wherein the slide latch assembly is further comprised of:
a second stationary latch rail coupled to a second bed rail of a vehicle that is opposite the first bed rail, wherein the second stationary latch rail includes a plurality of notches in a top edge thereof;
a second slide latch rail that is disposed parallel to and in slidingly engagement with the second stationary latch rail, wherein the second slide latch rail may be moved forward or backward a predetermined distance relative to the first stationary latch rail, wherein a plurality of locking points are disposed in a top edge of the second slide latch rail;
wherein the plurality of notches in the second stationary latch rail are aligned with the plurality of locking points in the second slide latch rail;
a plurality of tonneau cover attachment pins, wherein each of the plurality of tonneau cover attachment pins is coupled to a different section of a hinged and folding tonneau cover;
wherein the plurality of tonneau cover pins rests in the plurality of notches of the second stationary latch rail when the tonneau cover is unfolded on the bed rails of the vehicle; and
wherein the locking points of the second slide latch rail are either positioned to secure the plurality of tonneau cover pins in the plurality of notches or are positioned to expose the plurality of tonneau cover pins, by sliding the second slide latch rail forward or backward relative to the second stationary latch rail.

3. The slide latch assembly as defined in claim 2 wherein the plurality of locking points are each further comprised of an aperture through the first slide latch rail, wherein each aperture also includes an opening on a top edge of the first slide latch rail such that one of the plurality of tonneau cover pins can slide down into each of the plurality of locking points.

4. The slide latch assembly as defined in claim 3 wherein the first slide latch rail is further comprised of a first slide latch handle that enables the first slide latch rail to be moved the predetermined distance in sliding engagement with the first stationary latch rail by pushing or pulling on the first slide latch handle.

5. The slide latch assembly as defined in claim 4 wherein the first slide latch rail is disposed between the first stationary latch rail and the bed of the vehicle.

6. The slide latch assembly as defined in claim 5 wherein the slide latch assembly is further comprised of all of the plurality of locking points being disposed through the first slide latch rail and having an opening at a first end of the locking point or at an opposite second end of the locking point;
wherein there is at least one locking point having an opening at the first end and at least one locking point having an opening at the second end; and
wherein when the first slide latch rail is pushed forward relative to the first stationary latch rail, at least one of the tonneau cover pins is covered by the locking point and at least one of the tonneau cover pins is not covered by the locking point.

7. The slide latch assembly as defined in claim 6 wherein the slide latch assembly is further comprised of the first slide latch rail being pulled back relative to the first stationary latch rail such that at least one of the tonneau cover pins is covered by the locking point and at least one of the tonneau cover pins is not covered by the locking point.

8. The slide latch assembly as defined in claim 7 wherein the slide latch assembly is further comprised of the first slide latch being disposed in a position between being pushed forward and pulled back, wherein all of the plurality of tonneau cover pins are covered by all of the locking points.

9. The slide latch assembly as defined in claim 7 wherein the slide latch assembly is further comprised of a torsion bar disposed between the first slide latch rail and the second slide latch rail, wherein the torsion bar enables pushing or pulling on the first or the second slide latch rail results in the same pushing or pulling on the slide latch rail that is not being pushed or pulled.

10. A method for selectively locking sections of a tonneau cover to a bed of a vehicle using a slide latch assembly, said method comprising:
providing a first stationary latch rail coupled to a first bed rail of a vehicle, wherein the first stationary latch rail includes a plurality of notches in a top edge thereof;
providing a first slide latch rail that is disposed parallel to and in slidingly engagement with the first stationary latch rail, wherein the first slide latch rail may be moved forward or backward a predetermined distance relative to the first stationary latch rail, wherein a plurality of locking points are disposed in a top edge of the first slide latch rail;
wherein the plurality of notches in the first stationary latch rail are aligned with the plurality of locking points in the first slide latch rail;
providing a plurality of tonneau cover attachment pins, wherein each of the plurality of tonneau cover attachment pins is coupled to a different section of a hinged and folding tonneau cover;
wherein the plurality of tonneau cover pins rests in the plurality of notches of the first stationary latch rail when the tonneau cover is unfolded on the bed rails of the vehicle;
wherein the locking points of the first slide latch rail are either positioned to secure the plurality of tonneau cover pins in the plurality of notches or are positioned to expose the plurality of tonneau cover pins; and
sliding the first slide latch rail forward or backward relative to the first stationary latch rail.

11. The method as defined in claim 10 wherein the method further comprises:
providing a second stationary latch rail coupled to a second bed rail of a vehicle that is opposite the first bed rail, wherein the second stationary latch rail includes a plurality of notches in a top edge thereof;
providing a second slide latch rail that is disposed parallel to and in slidingly engagement with the second stationary latch rail, wherein the second slide latch rail may be moved forward or backward a predetermined distance relative to the first stationary latch rail, wherein a plurality of locking points are disposed in a top edge of the second slide latch rail;
wherein the plurality of notches in the second stationary latch rail are aligned with the plurality of locking points in the second slide latch rail;
providing a plurality of tonneau cover attachment pins, wherein each of the plurality of tonneau cover attachment pins is coupled to a different section of a hinged and folding tonneau cover;
wherein the plurality of tonneau cover pins rests in the plurality of notches of the second stationary latch rail when the tonneau cover is unfolded on the bed rails of the vehicle; and
wherein the locking points of the second slide latch rail are either positioned to secure the plurality of tonneau cover pins in the plurality of notches or are positioned to expose the plurality of tonneau cover pins; and
sliding the second slide latch rail forward or backward relative to the second stationary latch rail.
